(19) United States
(12) Patent Application Publication
(10) Pub. No.: US 2014/0109693 A1
(43) Pub. Date: Apr. 24, 2014

(54) PRESSURE SENSING DEVICE AND MANUFACTURING METHOD OF THE SAME

(71) Applicant: DENSO CORPORATION, Kariya-city (JP)

(72) Inventor: Makoto Sakai, Kariya-city (JP)

(73) Assignee: DENSO CORPORATION, Kariya-city (JP)

(21) Appl. No.: 14/058,582

(22) Filed: Oct. 21, 2013

(30) Foreign Application Priority Data
Oct. 23, 2012 (JP) 2012-233779

(51) Int. Cl. G01L 1/26; G01L 19/14

(52) U.S. Cl. CPC G01L 1/26; G01L 19/148
USPC 73/862.382; 29/825

(57) ABSTRACT

A pressure sensing device includes a sensor chip having a sensing portion, a bonding wire electrically connected with the sensor chip, a protection section, and a package. The sensor chip detects a pressure with the sensing portion and generates a signal corresponding to the detected pressure. The protection section includes a first protection section and a second protection section. The first protection section includes a predetermined portion, which seals the sensing portion, and a remaining portion other than the predetermined portion. The second protection section is arranged on the remaining portion of the first protection section and seals at least the bonding wire so that the bonding wire is not exposed to an outside.

### CROSS REFERENCE TO RELATED APPLICATION

This application is based on Japanese Patent Application No. 2012-233779 filed on Oct. 23, 2012, the disclosure of which is incorporated herein by reference.

### TECHNICAL FIELD

The present disclosure relates to a pressure sensing device, which has a sensor chip, bonding wires, a protection section, and a package, and a manufacturing method of the pressure sensing device.

### BACKGROUND

As disclosed in JP 3858577 B2 (corresponding to US 2001/0028072 A1), a technology related to a semiconductor pressure sensing device that restricts a generation of a void caused by chemicals and moisture existing in the environment in a protection section is disclosed. The semiconductor pressure sensing device includes a conductive section, a sensor chip, bonding wires, and a protection section. The protection section is made of a material, which has a saturated swelling coefficient of 7 weight percent at most when the material is immersed into gasoline having a temperature of 20 Celsius degrees.

According to the technology disclosed in JP 3858577 B2, the protection section needs to be formed thickly in order to protect the sensor chip and the bonding wires. When the pressure sensing device having a thickly formed protection section is used to detect a collision, the sensor chip receives an effect of an impact acceleration caused by an external reason and the sensor chip may output a false detection result.

In order to reduce the effect caused by the impact acceleration, the protection section needs to be formed thinly. However, when the protection section is thinly formed, a reliability of the pressure sensing device may be reduced caused by an exposure of the bonding wires and the like.

### SUMMARY

In view of the foregoing difficulties, it is an object of the present disclosure to provide a pressure sensing device, which reduces an effect caused by an impact acceleration and secures a reliability of a bonding wire, and a manufacturing method of the pressure sensing device.

According to a first aspect of the present disclosure, a pressure sensing device includes a sensor chip having a sensing portion, a bonding wire, a protection section, and a package. The sensor chip detects a pressure with the sensing portion and generates a signal corresponding to the pressure detected by the sensing portion. The bonding wire is electrically connected with the sensor chip in order to transmit the signal generated by the sensor chip. The protection section has an electrical insulation property and seals the sensor chip and the bonding wire. The sensor chip, the bonding wire, and the protection section are arranged in the package. The protection section includes a first protection section and a second protection section. The first protection section includes a predetermined portion and a remaining portion other than the predetermined portion. The predetermined portion of the first protection section seals the sensing portion of the sensor chip. The second protection section is arranged on the remaining portion of the first protection section and seals at least the bonding wire so that the bonding wire is not exposed to an outside.

With the above device, an effect caused by impact acceleration is reduced and a reliability of the bonding wire is secured.

According to a second aspect of the present disclosure, a manufacturing method of the pressure sensing device according to the first aspect includes sealing at least the sensing portion of the sensor chip with the first protection section and arranging the second protection section on the remaining portion of the first protection section and sealing at least the bonding wire with the second protection section so that the bonding wire is not exposed to an outside.

With the above method, an effect caused by impact acceleration is reduced and a reliability of the bonding wire is secured.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram showing a cross-sectional view of a pressure sensing device according to a first embodiment of the present disclosure;

FIG. 2 is a diagram showing a cross-sectional view of the pressure sensing device during a position defining process;

FIG. 3 is a diagram showing a top view of a guide member of the pressure sensing device;

FIG. 4 is a diagram showing a cross-sectional view of the pressure sensing device when a position of the guide member is defined;

FIG. 5 is a diagram showing a cross sectional view of the pressure sensing device during a first sealing process;

FIG. 6 is a diagram showing a cross-sectional view of the pressure sensing device during a second sealing process;

FIG. 7 is a diagram showing an example in which the pressure sensing device is mounted to a vehicle;

FIG. 8 is a diagram showing a cross-sectional view of a pressure sensing device according to a second embodiment of the present disclosure; and

FIG. 9 is a diagram showing a cross-sectional view of the pressure sensing device during a guide member removing process.

### DETAILED DESCRIPTION

The following will describe embodiments of the present disclosure with reference to the drawings. In the present disclosure, the words “connect, connection” mean “electrically connect, electrical connection”. Similarly, the words “insulate, insulation” mean “electrically insulate, electrical insulation”.

### First Embodiment

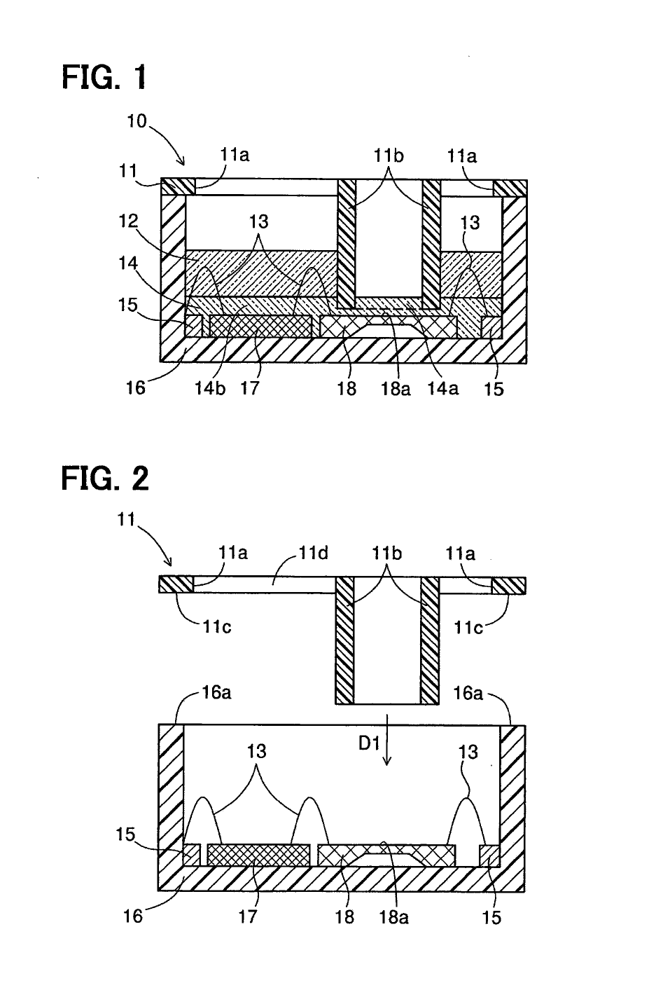

The following will describe a pressure sensing device 10 according to a first embodiment of the present disclosure with reference to FIG. 1 to FIG. 7. As shown in FIG. 1, the pressure sensing device 10 includes a guide member 11, bonding wires 13, a protection section 12, 14, leads 15, a package 16, a circuit chip 17, and a sensor chip 18. The circuit chip 17 includes an integrated circuit, and the leads 15 include lead frames. The protection section 12, 14 includes a first protection section 14 and a second protection section 12.

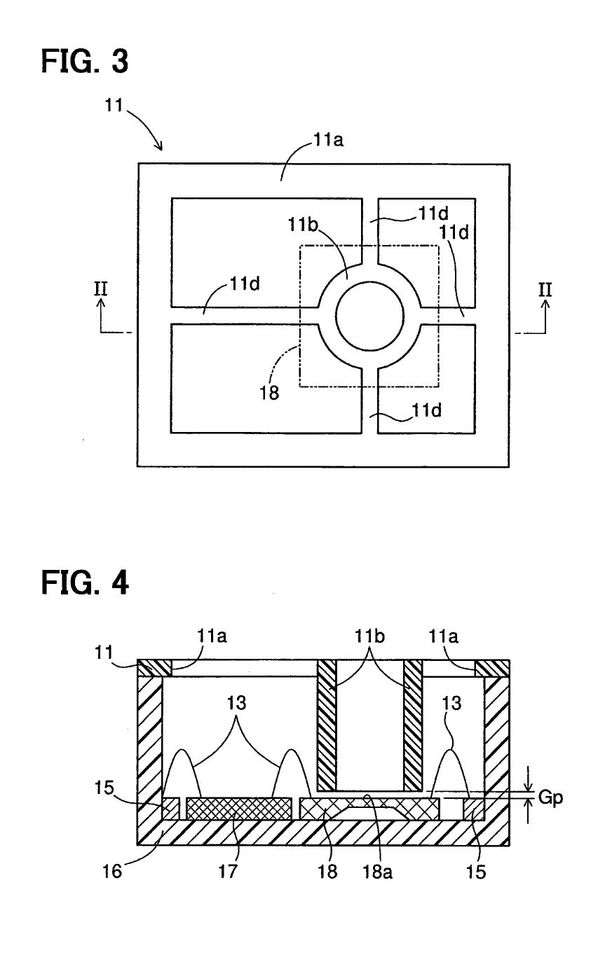

As shown in FIG. 1 to FIG. 3, the guide member 11 includes a positioning section 11a, a tubular section 11b, and a support section 11d. The positioning section 11a defines a position of the guide member 11 at a predetermined portion of the package 16. In the present embodiment, as shown in FIG. 2, an end part 11c of the positioning section 11a is contacted with an end part 16a of the package 16 so that the guide member 11 is arranged at the predetermined portion of the package 16. The end part 11c of the positioning section 11a may be contacted with the end part 16a of the package 16 by a surface, a point, or a line. That is, the positioning section 11a is shaped to fit with a shape of the end part 16a of the package 16. The tubular section 11b is formed so that the tubular section 11b is opposed to a sensing portion 18a of the sensor chip 18 when the position of the guide member 11 is defined by the positioning section 11a. As shown in FIG. 2 and FIG. 3, in the present embodiment, the tubular section 11b is shaped to have a cylindrical shape. Further, the tubular section 11b may have a different tube-shape under a condition that the sensing portion 18a of the sensor chip 18 is surrounded by the tubular section 11b. The support section 11d supports the tubular section 11b so that the tubular section 11b is arranged at a predetermined position opposed to the sensing portion 18a of the sensor chip 18.

As described above, the protection section 12, 14 includes the first protection section 14 and the second protection section 12, which is arranged on the first protection section 14. The first protection section 14 seals a part of each of the bonding wires 13, the leads 15, the circuit chip 17, and the sensor chip 18. The second protection section 12 is arranged on the first protection section 14, and seals the components, which are not sealed by the first protection section 14. Hereinafter, the components that are not sealed by the first protection section are also referred to as remaining components. Specifically, the second protection section 12 seals the remaining components except the sensing portion 18a of the sensor chip 18. That is, as shown in FIG. 1, the second protection section 12 seals remaining part of each of the bonding wires 13. The first protection section 14 and the second protection section 12 are made of gel material, which is gelatinized under a heating treatment. Herein, the gelatinization includes solidification, and the gel material includes resin material. In the present embodiment, the first protection section 14 and the second protection section 12 are made of the same material, such as silicon gel or fluorine gel.

The bonding wires 13 are conducting wires that transmit output signals of the sensor chip 18 to the leads 15 or to the circuit chip 17. The leads 15 are provided by conductors, which are used for terminals that transmit signals and information to internal wires of the pressure sensing device 10 and transmit signals and information output from the pressure sensing device 10 to an external device or circuit. The circuit chip 17 receives output signals of the sensor chip 18 and executes a necessary process to the output signals, such as an analog to digital conversion. The package 16 houses the bonding wires 13, the protection section 12, 14, the leads 15, the circuit chip 17, and the sensor chip 18. The package 16 may have any shape and configuration and may be made of any material under a condition that the package 16 is able to house the bonding wires 13, the protection section 12, 14, the leads 15, the circuit chip 17, and the sensor chip 18. In the present embodiment, the package 16 is made of resin material and has a box shape with one opening on a surface.

In the present embodiment, the sensor chip 18 includes a pressure sensor that corresponds to the sensing portion 18a. The pressure sensor detects a pressure, particularly an air pressure. The pressure sensor may be provided by any sensor that is able to detect a pressure, particularly an air pressure. For example, a piezo-resistive pressure sensor may be provided as the pressure sensor. The sensor chip 18 generates and outputs a signal that changes with the air pressure.

The following will describe a manufacturing method of the above-described pressure sensing device 10 with reference to FIG. 2 to FIG. 6. The manufacturing method includes a position defining process, a first sealing process, and a second sealing process. An execution order of the position defining process and the first sealing process may be switched. The following will describe each manufacturing process of the manufacturing method of the pressure sensing device 10. In the present embodiment, suppose that the leads 15, the circuit chip 17, the sensor chip 18 are properly arranged in the package 16 and the connection points are connected by the bonding wires 13 before carrying out the manufacturing processes.

(Position Defining Process)

In the position defining process, the position of the guide member 11 is defined with respect to the package 16. Specifically, as shown in FIG. 2 by an arrow D1, the guide member 11 is moved in an approaching direction toward the package 16, and arranged on the package 16 by contacting the end part 11c of the positioning section 11a with the end part 16a of the package 16. Further, the guide member 11 may be fixed to the package 16 after arranging the guide member 11 on the package 16.

In the present embodiment, the guide member 11 has a shape shown in FIG. 2 and FIG. 3. The positioning section 11a of the guide member 11 is shaped to fit with the end part 16a of the package 16, which is arranged adjacent to the opening of the package 16. The tubular section 11b of the guide member 11 may have any tube shape. In the present embodiment, the tubular section 11b has a cylindrical shape. The support section 11d of the guide member 11 supports the tubular section 11b so that the tubular section 11b is opposed to the sensor chip 18, particularly opposed to the sensing portion 18a of the sensor chip 18. In the present embodiment, as shown in FIG. 3, the support section 11d has four sub sections to support the tubular section 11b. However, the number of the sub sections of the support section 11d and the shape of the support section 11d are not limited to the example shown in FIG. 3.

FIG. 4 shows a state after the position of the guide member 11 is defined with respect to the package 16. As shown in FIG. 4, a cross-sectional end surface of the guide member 11 is spaced from the sensor chip 18 by a gap Gp. More specifically, a cross-sectional end surface of the tubular section 11b of the guide member 11 is spaced from a surface of the sensing portion 18a of the sensor chip by a gap Gp. The material of the first protection section 14 flows to an inside portion of the tubular section 11b via the gap Gp. Thus, a thickness of the protection section, which is necessary to protect the sensing portion 18a, is secured. In this case, since the protection section on the sensing portion 18a is provided by the first protection section 14 only, the thickness of the protection section is equal to a thickness of the first protection section 14.

(First Sealing Process)

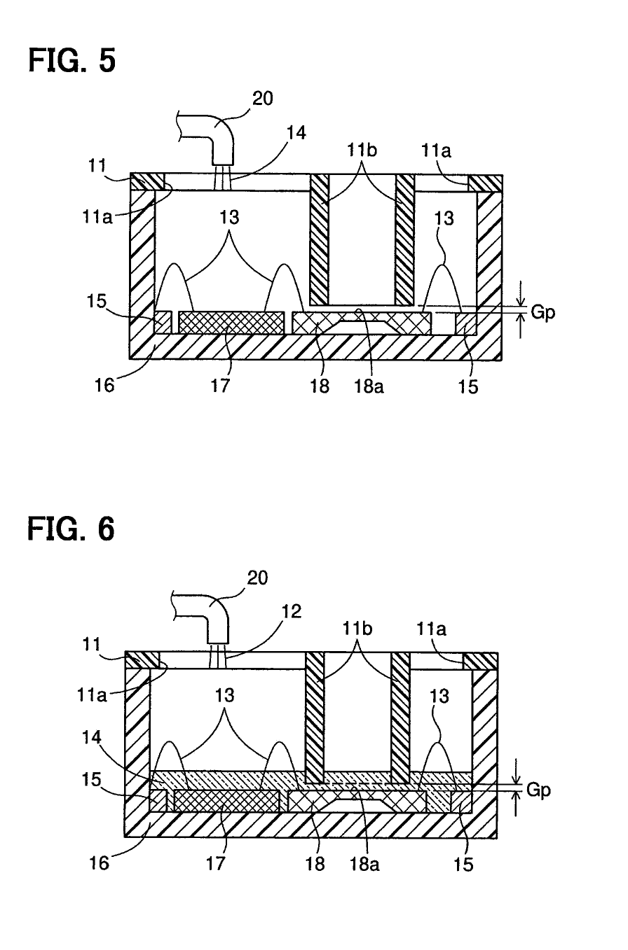

In the first sealing process, the first protection section 14 seals at least the sensing portion 18a of the sensor chip 18. Specifically, as shown in FIG. 5, an inside portion of the package 16 is filled with the fluid material of the first protection section 14. The fluid material of the first protection section 14 is provided by a providing apparatus 20. As shown in FIG. 4, since the material of the first protection section 14 has the fluid state, the material of the first protection section 14 moves in the package 16 and seals a part of each of the bonding wires 13, the leads 15, the circuit chip 17 and the sensor chip 18. As described above, the material of the first protection section 14 also flows to the inside portion of the tubular section lib via the gap Gp. After the material of the first protection section 14 filled in the package 16 has a predetermined thickness, a heating treatment is performed to the material of the first protection section 14 so that the material of the first protection section 14 changes from the fluid state to a gel state. The material of the first protection section 14 filled in the package 16 changes from the fluid state to the gel state when being heated for a predetermined time, and the first protection section 14 having the gel state is formed. The predetermined time changes with the predetermined thickness of the first protection section 14 and a temperature of the heating treatment.

(Second Sealing Process)

In the second sealing process, the second protection section 12 seals the remaining components in the package 16 except the sensing portion 18a of the sensor chip 18. Specifically, an outside portion of the tubular section 11b in the package 16 is filled with the fluid material of the second protection section 12. The fluid material of the second protection section 12 is also provided by the providing apparatus 20. Since the material of the second protection section 12 has the fluid state, the material of the second protection section 12 moves in the package 16 and seals the remaining part of each of the bonding wires 13 as shown in FIG. 1. When the remaining part of each of the bonding wires 13 is entirely sealed by the material of the second protection section 12, a heating treatment is performed to the material of the second protection section 12 so that the material of the second protection section 12 changes from the fluid state to a gel state. The material of the second protection section 12 changes from the fluid state to the gel state when being heated for a predetermined time, and the second protection section 2 having he gel state is formed. The predetermined time changes with a predetermined thickness of the second protection section 12 and a temperature of the heating treatment. With above-described processes, the pressure sensing device 10 is manufactured.

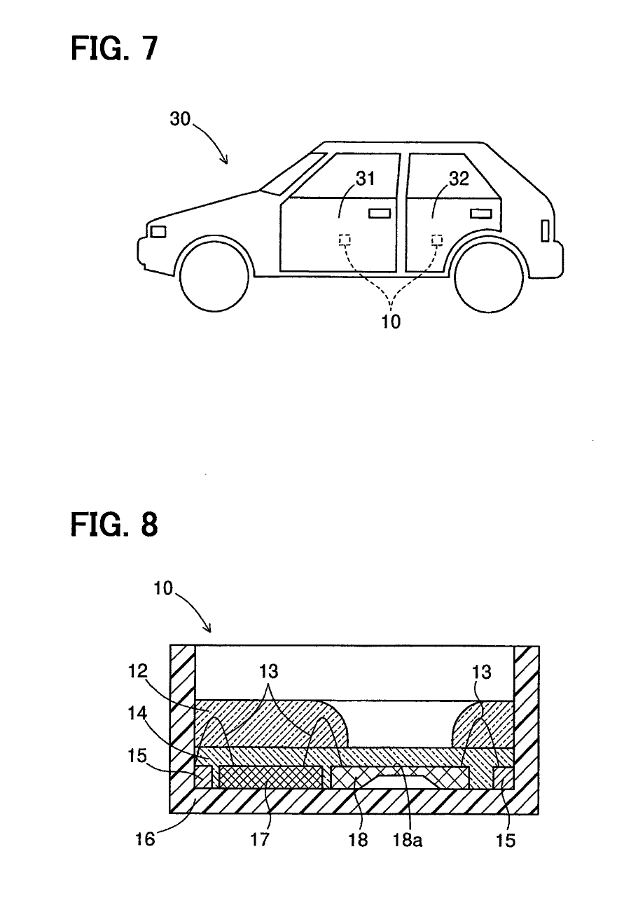

The following will describe an example in which the above-described pressure sensing device 10 is mounted to a target. As shown in FIG. 7, the pressure sensing device 10 is arranged at an inside portion of each door 31, 32 of a vehicle 30. With this configuration, when a collision occurs to a side portion of the vehicle 30 and the collision causes a deformation of the door 31, 32, the pressure sensing device 10, specifically the sensor chip 18 detects a change of the air pressure caused by the deformation of the door 31, 32 in order to determine whether to activate a side airbag or a curtain shield airbag of the vehicle 30. Further, except the doors 31, 32 of the vehicle 30, the pressure sensing device 10 may be mounted to a portion of the vehicle 31 at where the air pressure changes in response to the collision.

As shown in FIG. 1, in the pressure sensing device 10 according to the present embodiment, the sensing portion 18a of the sensor chip 18 is sealed and protected only by the first protection section 14. When the collision occurs to the door 31, 32 of the vehicle 30 by any reason, the sensor chip 18 of the pressure sensing device 10 mounted to the door 31, 32 detects a pressure change caused by an impact received at the door 31, 32. When the collision occurs to the door 31, 32 of the vehicle 30, the sensing portion 18a of the sensor chip 18 is subject to an acceleration of the impact caused by the collision occurred to the door 31, 32. The acceleration of the impact applied to the sensing portion 18a is defined by a mass of the first protection section 14 sealed on the sensing portion 18a. The protection section (the first protection section 14) sealed on the sensing portion 18a has a thickness smaller than the thickness of the protection section (the first protection section 14 and the second protection section 12) sealed on the remaining components in the package 16. Thus, when the sensing portion 18a is sealed only by the first protection section 14, the acceleration of the impact applied to the sensing portion 18a is smaller compared with a case in which the sensing portion 18a is sealed by both the first protection section 14 and the second protection section 12. Thus, when the sensing portion 18a detects the pressure change, an abnormal effect of the impact acceleration applied to the sensing portion 18a is reduced. The pressure sensing device 10 detects the pressure change of the air disposed inside of the door 31, 32. Thus, each door 31, 32 needs only one pressure sensing device 10 to detect the pressure change.

In the present embodiment, the remaining components arranged in the package 16 except the sensing portion 18a are sealed by the first protection section 14 and the second protection section 12. That is, the bonding wires 13 are securely sealed by both the first protection section 14 and the second protection section 12. Thus, a fault caused by an exposure of the bonding wires 13 is restricted, and accordingly, a reliability of the pressure sensing device 10 is secured.

The following will describe advantages provided by the pressure sensing device 10 according to the present embodiment.

(I) In the present embodiment, as shown in FIG. 1, the pressure sensing device 10 includes the first protection section 14 and the second protection section 12 arranged on the first protection section 14. The first protection section 14 seals at least the sensing portion 18a of the sensor chip 18. The second protection section 12 seals remaining part of each of the bonding wires 13 so that the bonding wires 13 are not exposed to an outside and seals the remaining components arranged in the package 16 except the sensing portion 18a of the sensor chip 18. Specifically, as shown in FIG. 1, when a portion of the first protection section 14 corresponding to the sensing portion 18a of the sensor chip 18 is defined as a predetermined portion 14a, the second protection section 12 is formed on a remaining portion 14b of the first protection section 14 other than the predetermined portion 14a. With this configuration, the sensor chip 18, particularly the sensing portion 18a is sealed by the first protection section 14 only. Thus, the thickness of the protection section (the first protection section 14) sealed on the sensor chip 18 is smaller than the thickness of the protection section (the first protection section 14 and the second protection section 12) sealed on the remaining components arranged in the package 16. Thus, the effect of the impact acceleration is reduced at the sensing portion 18a, and a false detection of the sensor chip 18 is substantially restricted. Further, the bonding wires 13 are sealed by both the first protection section 14 and the second protection section 12. Thus, a fault caused by an exposure of the bonding wires 13 is restricted and a reliability of the pressure sensing device 10 is secured. Compared with a configuration in which the sensing portion 18a is sealed by the first protection section 14 and the second protection section 12, a cost needed for sealing the sensing portion 18a with the second protection section 12 is reduced.

(II) In the present embodiment, the pressure sensing device 10 includes the guide member 11, which includes the tubular section 11b arranged opposed to the sensing portion 18a. As shown in FIG. 1 and FIG. 6, the material of the second protection section 12 is filled in the outside portion of the tubular section 11b in the package 16. With this configuration, the second protection section 12 does not seal the sensor chip 18, particularly the sensing portion 18a. Thus, the thickness of the protection section (first protection section 14) sealed on the sensor chip 18 is smaller than the thickness of the protection section (first protection section 14 and the second protection section 12) sealed on the remaining components. Thus, the effect caused by the impact acceleration is securely reduced at the sensor chip 18.

(III) In the present embodiment, the guide member 11 includes the positioning section 11a that is arranged on the predetermined portion of the package 16. Specifically, as shown in FIGS. 2 and FIG. 4, when the positioning section 11a is arranged on the end part 16a of the package 16, the cross-sectional end surface of the guide member 11 is spaced from the surface of the sensor chip 18 by the gap Gp. With this configuration, the gap Gp having a predetermined width is secured by defining the position of the guide member 11. The gap Gp enables the material of the first protection section 14 flows to the inside portion of the tubular section 11b so that the sensor chip 18, particularly the sensing portion 18a is sealed by the first protection section 14 and is not sealed by the second protection section 12.

(IV) In the present embodiment, the first protection section 14 and the second protection section 12 are made of the material, which is gelatinized under the heating treatment, and the first protection section 14 and the second protection section 12 are made of the same material. Further, the first protection section 14 and the second protection section 12 may be made of different materials, which are gelatinized under respective heating treatments. Since the first protection section 14 and the second protection section 12 are made of the materials, which are gelatinized under the heating treatment, the sealing of the components can be performed with ease.

(V) In the present embodiment, as shown in FIG. 5 and FIG. 6, the manufacturing method of the pressure sensing device 10 includes the first sealing process and the second sealing process. In the first sealing process, at least the sensing portion 18a of the sensor chip 18 is sealed by the first protection section 14. In the second sealing process, the second protection section 12 is arranged on the first protection section 14 and seals remaining part of each of the bonding wires 13 so that the bonding wires 13 are not exposed to the outside and seals the remaining components arranged in the package 16 except the sensing portion 18a. With this method, the sensor chip 18, particularly the sensing portion 18a is sealed by the first protection section 14 and is not sealed by the second protection section 12. Thus, the thickness of the protection section (the first protection section 14) sealed on the sensor chip 18 is smaller than the thickness of the protection section (the first protection section 14 and the second protection section 12) sealed on the remaining components arranged in the package 16. Thus, the effect of the impact acceleration is reduced at the sensing portion 18a, and a false detection of the sensor chip 18 is substantially restricted. Further, with this method, the bonding wires 13 are entirely sealed by both the first protection section 14 and the second protection section 12. Thus, a fault caused by an exposure of the bonding wires 13 is restricted and a reliability of the pressure sensing device 10 is secured.

(VI) In the present embodiment, as shown in FIG. 2 and FIG. 6, the manufacturing method of the pressure sensing device 10 further includes the position defining process. In the position defining process, the position of the guide member 11 is defined with respect to the package 16 so that the tubular section 11b of the guide member 11 is opposed to the sensing portion 18a. In the second sealing process, the material second protection section 12 is filled in the outside portion of the tubular section 11b in the package 16. With this process, since the second protection section 12 is arranged in the outside portion of the tubular section 11b in the package 16, the sensor chip 18, particularly the sensing portion 18a is not sealed by the second protection section 12. Thus, the thickness of the protection section (first protection section 14) sealed on the sensor chip 18 is smaller than the thickness of the protection section (first protection section 14 and the second protection section 12) sealed on the remaining components. Thus, the effect caused by the impact acceleration is securely reduced at the sensor chip 18.

### Second Embodiment

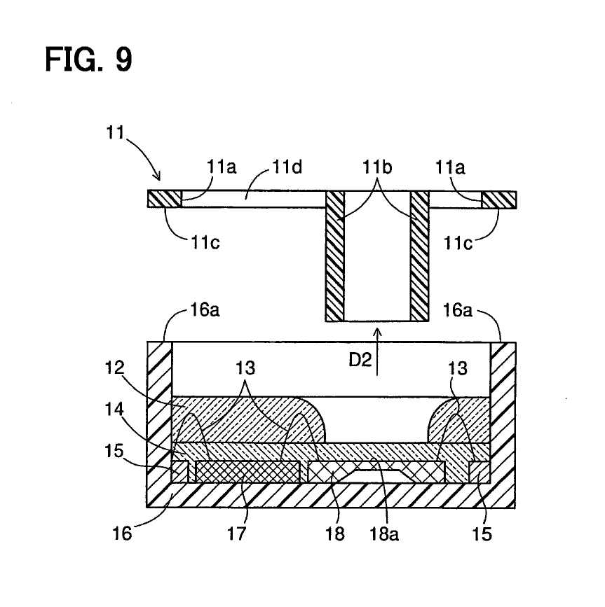

The following will describe a pressure sensing device 10 according to a second embodiment of the present disclosure with reference to FIG. 8 and FIG. 9. The following will describe different parts of the pressure sensing device 10 according to the second embodiment compared with the pressure sensing device 10 according to the first embodiment. In the drawings, same reference numbers are used for the same or equal part with the first embodiment.

As shown in FIG. 8, the pressure sensing device 10 according to the present embodiment does not include the guide member 11 compared with the pressure sensing device 10 according to the first embodiment. Further, in the present embodiment, the second protection section 12 is made of material, which has a lower fluidity, compared with the material of the first protection section 14. In the pressure sensing device 10 according to the present embodiment, the components sealed by the first protection section 14 and the components sealed by the second protection section 12 are the same with the pressure sensing device 10 according to the first embodiment.

The following will describe a manufacturing method of the pressure sensing device 10 according to the present embodiment with reference to FIG. 2, FIG. 5, FIG. 6, and FIG. 9. The manufacturing method includes an attaching process, a first sealing process, a second sealing process, and a removing process. In the attaching process, the guide member 11 is attached to the pressure sensing device 10, and in the removing process, the guide member 11 is removed from the pressure sensing device. Thus, the attaching process is also referred to as a guide member attaching process, and the removing process is also referred to as a guide member removing process. In the present embodiment, the guide member attaching process and the guide member removing process are carried out instead of the position defining process of the first embodiment. The following will describe manufacturing processes of the pressure sensing device 10 of the present embodiment, which are different from the manufacturing processes of the pressure sensing device 10 of the first embodiment.

(Attaching Process)

The attaching process in the present embodiment is similar to the position defining process in the first embodiment. As shown in FIG. 2 by an arrow D1, the guide member 11 is moved in the approaching direction toward the package 16, and arranged on the package 16 by contacting the end part 11c of the positioning section 11a with the end part 16a of the package 16.

(Second Sealing Process)

In the second sealing process, the material of the second protection section 12 provided by the providing apparatus 20 is different from the material of the second protection section 12 in the first embodiment. In the present embodiment, the material of the second protection section 12 has a lower fluidity compared with the material of the second protection section 12 of the first embodiment. Similar to the first embodiment, the material of the second protection section 12 to be filled at the outside portion of the tubular section 11b in the package 16 may have the fluid state or the gel state. Further, only an outside surrounding portion of the tubular section 11b may be sealed by the second protection section 12 having the lower fluidity, and other outside portion may be sealed by the second protection section 12, which is the same with the second protection section 12 in the first embodiment. The tubular section 11b and the second protection section 12 are attached together such that the guide member 11 can be removed in the removing process, which will be described.

(Removing Process)

The removing process is carried out after the material of the second protection section 12 is gelatinized by the heating treatment. Specifically, as shown in FIG. 9 by an arrow D2, the guide member 11 is moved in a direction apart from the package 16 in order to remove the guide member 11 from the package 16. Thus, the guide member 11 may be reused in other manufacturing process.

The following will describe advantages provided by the pressure sensing device 10 according to the present embodiment. The pressure sensing device 10 according to the present embodiment provides advantages similar to the above-described advantages (I), (II), (IV), (V), which are provided by the pressure sensing device 10 according to the first embodiment. Further, the pressure sensing device 10 according to the present embodiment provides the following advantage.

(VII) In the present embodiment, as shown in FIG. 2 and FIG. 9, the guide member 11 is attached to the package 16 in the attaching process prior to the second sealing process, and is removed from the package 16 in the removing process after the second sealing process. With this configuration, the pressure sensing device 10, which does not include the guide member 11, can be manufactured. Further, the guide member 11 can be reused in the manufacturing process.

### Other Embodiments

While only the selected exemplary embodiments including the first embodiment and the second embodiment have been chosen to illustrate the present disclosure, it will be apparent to those skilled in the art from this disclosure that various changes and modifications can be made therein without departing from the scope of the disclosure as defined in the appended claims. Furthermore, the foregoing description of the exemplary embodiments according to the present disclosure is provided for illustration only, and not for the purpose of limiting the disclosure as defined by the appended claims and their equivalents. The following will describe other embodiments of the present disclosure.

In the foregoing embodiments, as shown in FIG. 2 to FIG. 6 and FIG. 9, after arranging the guide member 11 in the position defining process or in the attaching process, the first protection section 14 is formed to seal at least the sensing portion 18a of the sensor chip 18 in the first sealing process. Then, the second protection section 12 is formed to seal the remaining components in the package 16 except the sensing portion 18a of the sensor chip 18 in the second sealing process. Further, the first sealing process may be performed at first so that the first protection section 14 is formed to seal at least the sensing portion 18a of the sensor chip 18, and then the position defining process or the attaching process may be performed so that the guide member 11 is arranged on the package 16. Then, the second sealing process may be performed so that the second protection section 12 is formed to seal the remaining components in the package 16 except the sensing portion 18a of the sensor chip 18. With this configuration, the sensing portion 18a is not sealed by the second protection section 12. Thus, similar advantages to the pressure sensing device 10 according to the foregoing embodiments are provided.

In the foregoing embodiments, as shown in FIG. 3, the support section 11d includes the four sub sections that support the tubular section 11b. Further, the number of the sub sections of the support section 11d may be other than four. As shown in FIG. 3, the positioning section 11a and the support section 11d are formed so that a part of the opening of the package 16 is remained so that the material of the second protection section 12 and the material of the first protection section 14 are provided through the remained opening of the package 16 to the inside portion of the package 16. The positioning section 11a and the support section 11d may have a shape other than the example shown in FIG. 3 under a condition that the material of the second protection section 12 and the material of the first protection section 14 can be provided through the remained opening of the package 16 to the inside portion of the package 16.

In the foregoing embodiments, as shown in FIG. 4, the guide member 11 is arranged so that the cross-sectional end surface of the guide member 11 is spaced from the surface of the sensor chip 18 by the gap Gp. Further, the guide member 11 may be arranged so that the cross-sectional end surface of the guide member 11 is contacted with the surface of the sensor chip 18 without the gap Gp. When the tubular section 11b of the guide member 11 is contacted with the sensing portion 18a of the sensor chip 18, a notch, a through hole or a slit may be formed on the tubular section 11b so that the material of the first protection section 14 flows to the inside portion of the tubular section 11b. A configuration other than the notch, the through hole, the slit may be formed on the tubular section 11b under a condition that the material of the first protection section 14 can flow to the inside portion of the tubular section 11b. With this configuration, the sensing portion 18a of the sensor chip 18 is sealed by the first protection section 14 only, and the bonding wires 13 are sealed by both the first protection section 14 and the second protection section 12. Thus, advantages similar to the advantages provided by the pressure sensing device 10 according to the foregoing embodiments are provided by this configuration.

What is claimed is:

1. A pressure sensing device comprising:
a sensor chip having a sensing portion, the sensor chip detecting a pressure with the sensing portion and generating a signal corresponding to the pressure detected by the sensing portion;
a bonding wire that is electrically connected with the sensor chip in order to transmit the signal generated by the sensor chip;
a protection section having an electrical insulation property and sealing the sensor chip and the bonding wire; and
a package, in which the sensor chip, the bonding wire, and the protection section are arranged,
wherein the protection section includes:
a first protection section that has a predetermined portion and a remaining portion other than the predetermined portion, the predetermined portion sealing the sensing portion of the sensor chip; and
a second protection section arranged on the remaining portion of the first protection section and sealing at least the bonding wire so that the bonding wire is not exposed to an outside.

2. The pressure sensing device according to claim 1, further comprising
a guide member having a tubular section that is arranged opposed to the sensing portion of the sensor chip,
wherein the second protection section is arranged at an outside portion of the tubular section in the package so that at least the bonding wire is sealed by the second protection section and the sensing portion of the sensor chip is not sealed by the second protection section.

3. The pressure sensing device according to claim 2,
wherein the guide member includes a positioning section that defines a position of the guide member with respect to the package, and
wherein, when the position of the guide member is defined by the positioning section, a cross-sectional end surface of the guide member is spaced from a surface of the sensor chip by a gap.

4. The pressure sensing device according to claim 1,
wherein at least one of the first protection section and the second protection section is made of gel material.

5. A manufacturing method of the pressure sensing device according to claim 1 comprising:
sealing at least the sensing portion of the sensor chip with the first protection section; and
arranging the second protection section on the remaining portion of the first protection section and sealing at least the bonding wire with the second protection section so that the bonding wire is not exposed to an outside.

6. The manufacturing method according to claim 5, further comprising
arranging a guide member having a tubular section so that the tubular section is opposed to the sensing portion of the sensor chip,
wherein the second protection section is arranged at an outside portion of the tubular section in the package.

7. The manufacturing method according to claim 6, further comprising
removing the guide member from the pressure sensing device,
wherein the arranging of the guide member is performed prior to the sealing of the bonding wire with the second protection section, and wherein the removing of the guide member is performed after the sealing of the bonding wire with the second protection section.
